(19) United States
(12) Patent Application Publication
(10) Pub. No.: US 2023/0299335 A1
(43) Pub. Date: Sep. 21, 2023

(54) PRODUCTION METHOD FOR SULFIDE SOLID ELECTROLYTE

(71) Applicant: IDEMITSU KOSAN CO., LTD., Tokyo (JP)

(72) Inventors: Yuma KITAMURA, Chiba-shi (JP); Masayuki SHIBATA, Chiba-shi (JP); Tomoyuki OKUYAMA, Ichihara-shi (JP)

(73) Assignee: IDEMITSU KOSAN CO., LTD., Tokyo (JP)

(21) Appl. No.: 18/119,924

(22) Filed: Mar. 10, 2023

(30) Foreign Application Priority Data
Mar. 15, 2022 (JP) 2022-040508

(51) Int. Cl. H01M 10/0562

(52) U.S. Cl. CPC H01M 10/0562; H01M 2300/008

(57) ABSTRACT

Provided is a production method for a sulfide solid electrolyte capable of producing a sulfide solid electrolyte for which the production process is not complicated and which can produce a sulfide solid electrolyte having a small particle diameter (having a large specific surface) and having a small oil absorption amount, according to a production method for a sulfide solid electrolyte which includes mixing a raw material inclusion containing a lithium atom, a sulfur atom, a phosphorus atom and a halogen atom, and a complexing agent to obtain an electrolyte precursor, removing the complexing agent from the electrolyte precursor to obtain a complex degradate, heating the complex degradate to obtain a crystalline complex degradate, and pulverizing the crystalline complex degradate by applying thereto a mechanical treatment with an integrated energy amount of 10 Wh/kg or more and less than 500 Wh/kg to obtain a pulverized product.

### TECHNICAL FIELD

The present invention relates to a sulfide solid electrolyte production method.

### BACKGROUND ART

With rapid spread of information-related instruments, communication instruments and so on, such as personal computers, video cameras, and mobile phones, in recent years, development of batteries that are utilized as a power source therefor is considered to be important. Heretofore, in batteries to be used for such an application, an electrolytic solution containing a flammable organic solvent has been used. However, development of batteries having a solid electrolyte layer in place of an electrolytic solution is being made in view of the fact that by making the battery fully solid, simplification of a safety unit may be realized without using a flammable organic solvent within the battery, and the battery is excellent in manufacturing costs and productivity.

As a production method for a solid electrolyte for use in a solid electrolyte layer, a liquid-phase method attracts attention as a method of simple and mass-scale synthesis. However, in a liquid-phase method, it is difficult to precipitate a solid electrolyte with maintaining the dispersion state of atoms to constitute it, and therefore disclosed is a method for production of a solid electrolyte via an electrolyte precursor further using a complexing agent (for example, see PTLs 1 and 2).

### CITATION LIST

### Patent Literature

PTL 1: WO 2020/105736
PTL 2: WO 2020/105737

### SUMMARY OF INVENTION

### Technical Problem

In view of the above-mentioned circumstances, the present invention has been made, and an object thereof is to provide a production method for a sulfide solid electrolyte having a small particle diameter (having a large specific surface area) and having a small oil absorption amount, without complicating the production step.

### Solution to Problem

The present inventors have made assiduous studies for the purpose of solving the above-mentioned problems and, as a result, have found that the problems can be solved by the following invention.
[1] A method for producing a sulfide solid electrolyte including:
   mixing a raw material inclusion containing a lithium atom, a sulfur atom, a phosphorus atom and a halogen atom, and a complexing agent to obtain an electrolyte precursor,
   removing the complexing agent from the electrolyte precursor to obtain a complex degradate,
   heating the complex degradate to obtain a crystalline complex degradate, and
   pulverizing the crystalline complex degradate by applying thereto a mechanical treatment with an integrated energy amount of 10 Wh/kg or more and less than 500 Wh/kg to obtain a pulverized product.
[2] A sulfide solid electrolyte containing a lithium atom, a sulfur atom, a phosphorus atom, a halogen atom and 0.01 to 1.0% by mass of a complexing agent, of which the particle diameter (D50) of a cumulative volume of 50% in a laser diffraction scattering particle size distribution measuring method is 0.10 μm or more and less than 0.50 μm, and of which the particle diameter (D10) of a cumulative volume of 10% is 0.05 μm or more and less than 0.15 μm.

### Advantageous Effects of Invention

The present invention can provide a method for producing a sulfide solid electrolyte having a small oil absorption amount, without complicating the production step and without lowering the specific surface area.

### BRIEF DESCRIPTION OF DRAWINGS

FIG. 1 is a particle size distribution of the sulfide solid electrolyte obtained in Example 1.

FIG. 2 is a particle size distribution of the sulfide solid electrolyte obtained in Example 2.

FIG. 3 is a particle size distribution of the sulfide solid electrolyte obtained in Example 3.

FIG. 4 is a particle size distribution of the sulfide solid electrolyte obtained in Comparative Example 1.

FIG. 5 is a particle size distribution of the sulfide solid electrolyte obtained in Comparative Example 2.

FIG. 6 is an X-ray diffraction spectrum of the sulfide solid electrolyte obtained in Example 1.

FIG. 7 is a scanning photomicrograph (SEM) of the solid electrolyte powder obtained in Example 1.

FIG. 8 is a scanning photomicrograph (SEM) of the solid electrolyte powder obtained in Comparative Example 1.

### DESCRIPTION OF EMBODIMENTS

Embodiments of the present invention (hereinafter sometimes referred to as a “present embodiment”) are hereunder described. In this description, numerical values of an upper limit and a lower limit according to numerical value ranges of “or more”, “or less”, and “XX to YY” are each a numerical value which can be arbitrarily combined, and numerical values in Examples can also be used as numerical values of an upper limit and a lower limit, respectively. Preferred definitions can be employed in an arbitrary manner. Specifically, one preferred definition can be combined with any one or plural preferred definitions to employ them. A combination of preferred ones can be said to be more preferred.

(Knowledge that the Inventors Obtained in Reaching the Invention)

The present inventors have made assiduous studies for solving the above-mentioned problems and, as a result, have found out the following matters and completed the present invention.

Heretofore, a solid electrolyte is desired to have a small particle diameter from the viewpoint of performance and production of all-solid-state lithium batteries. In an all-solid-state lithium battery, the positive electrode material, the negative electrode material and the electrolyte are all solid, and accordingly when the particle diameter of the solid electrolyte is small, the contact interface between the active substance and the solid electrolyte is easy to form, which therefore provides an advantage of a good path between the ionic conduction and electronic conduction.

On the other hand, in the production method described in PTLs 1 and 2, the solid electrolyte before mechanical treatment, which is a crystalline complex degradate, is characterized in that it is coarse and porous (having a large specific area) and soft, and therefore a solvent is readily absorbed by the pores, that is, a large amount of a solvent is needed in forming the solid electrolyte into a slurry. Consequently, even though the solid electrolyte is desired to be ground, there still exist some problems in that the particle diameter of the solid electrolyte may rather increase to fail in attaining the object, or there may remain a large amount of coarse and porous particles owing to inhomogeneous mechanical treatment, and anyhow, the solid electrolyte comes to have a large oil absorption amount and makes it difficult to produce batteries. That is, in any of the approaches heretofore, the small particle diameter (large specific area) and the small oil absorption amount are in a trade-off relation, and it is difficult to satisfy both easy production of the battery and enhanced performance thereof.

As a solution, the present inventors have specifically noted various conditions in mechanical treatment for a crystalline complex degradate, and have found that, by employing a mechanical treatment under milder conditions with reducing the integrated energy amount than before, extremely fine and poorly porous particles capable of satisfying both reduction in oil absorption and increase in specific surface area can be realized.

The production method for a sulfide solid electrolyte of the first mode of the present embodiment is a production method for a sulfide solid electrolyte including:
(1) mixing a raw material inclusion containing a lithium atom, a sulfur atom, a phosphorus atom and a halogen atom, and a complexing agent to obtain an electrolyte precursor,
(2) removing the complexing agent from the electrolyte precursor to obtain a complex degradate,
(3) heating the complex degradate to obtain a crystalline complex degradate, and
(4) pulverizing the crystalline complex degradate by applying thereto a mechanical treatment with an integrated energy amount of 10 Wh/kg or more and less than 500 Wh/kg to obtain a pulverized product.

As mentioned above, in the production method for a sulfide solid electrolyte described in PTLs 1 and 2, it is difficult to produce a solid electrolyte having a small particle diameter and a small oil absorption amount.

As opposed to this, in the production method for a sulfide solid electrolyte of the first mode, by pulverizing a crystalline complex degradate by applying thereto a mechanical treatment with a predetermined integrated energy amount, both the two performances of a small particle diameter and a small oil absorption amount can be satisfied.

The production method for a sulfide solid electrolyte of the second mode of the present embodiment is:
a production method for a sulfide solid electrolyte of the first mode, wherein the pulverization treatment for the crystalline complex degradate is performed in a solvent containing an oxygen atom-containing compound.

By carrying out the pulverization treatment for the crystalline complex degradate in a solvent containing an oxygen atom-containing compound, coarse particles can be efficiently pulverized and the remaining complexing agent becomes easy to remove.

The production method for a sulfide solid electrolyte of the third mode of the present embodiment is:
a production method for a sulfide solid electrolyte of the second mode, in which the oxygen atom-containing compound is an ether compound.

The production method for a sulfide solid electrolyte of the fourth mode of the present embodiment is:
a production method for a sulfide solid electrolyte of the second or third mode, in which the solvent further contains a hydrocarbon compound.

Further, the production method for a sulfide solid electrolyte of the fifth mode of the present embodiment is:
a production method for a sulfide solid electrolyte of the fourth mode, in which the solvent contains 50 to 99.5% by mass of the hydrocarbon compound and 0.5 to 50% by mass of the oxygen atom-containing compound.

The solvent for use for pulverization treatment for the crystalline complex degradate is, from the viewpoint of grinding coarse particles and removing the remaining complexing agent, preferably one containing the above-mentioned ether compound or hydrocarbon compound, and preferably contains the hydrocarbon compound and the oxygen atom-containing compound in the ratio mentioned above.

The production method for a sulfide solid electrolyte of the sixth mode of the present embodiment is:
a production method for a sulfide solid electrolyte of any one of the first to fifth modes, in which removal of the complexing agent from the electrolyte precursor is performed by drying.

Removal of the complexing agent from the electrolyte precursor can be carried out simply by drying.

The production method for a sulfide solid electrolyte of the seventh mode of the present embodiment is:
a production method for a sulfide solid electrolyte of any one of the first to sixth modes, further including heating the pulverized product.

Even though a part or all of the pulverized product has been vitrified (amorphized), it can be again crystallized by heating.

The production method for a sulfide solid electrolyte of the eighth mode of the present embodiment is:
a production method for a sulfide solid electrolyte of any one of the first to seventh modes, in which the complexing agent is a nitrogen atom-containing compound.

The production method for a sulfide solid electrolyte of the ninth mode of the present embodiment is:
a production method for a sulfide solid electrolyte of the eighth mode, in which the nitrogen atom-containing compound is a compound having a tertiary amino group.

The case of using a nitrogen atom-containing compound or a tertiary amino group-containing compound as the complexing agent is preferred from the viewpoint of improving the ionic conductivity since the complexing agent can become easy to remove.

The production method for a sulfide solid electrolyte of the tenth mode of the present embodiment is:
a production method for a sulfide solid electrolyte of any one of the first to ninth modes, in which the particle diameter (D50) of a cumulative volume of 50% of the crystalline complex degradate in a laser diffraction scattering particle size distribution measuring method is less than 3.00 μm.

The production method for a sulfide solid electrolyte of the eleventh mode of the present embodiment is:
a production method for a sulfide solid electrolyte of any one of the first to tenth modes, in which the particle diameter (D90) of a cumulative volume of 90% of the crystalline complex degradate in a laser diffraction scattering particle size distribution measuring method is 5.00 μm or more.

In the production method for a sulfide solid electrolyte of the present embodiment, coarse porous particles is pulverized by applying a mechanical treatment to the crystalline complex degradate of which the particle diameter (D50) of a cumulative volume of 50% thereof or the particle diameter (D90) of a cumulative volume of 90% thereof each satisfy the above-mentioned range, and therefore a sulfide solid electrolyte having a small particle diameter and having a small oil absorption amount can be obtained efficiently.

The sulfide solid electrolyte of the twelfth mode of the present embodiment is:
a sulfide solid electrolyte containing a lithium atom, a sulfur atom, a phosphorus atom, a halogen atom and 0.01 to 1.0% by mass of a complexing agent, of which the particle diameter (D50) of a cumulative volume of 50% in a laser diffraction scattering particle size distribution measuring method is 0.10 μm or more and less than 0.50 μm, and of which the particle diameter (D10) of a cumulative volume of 10% is 0.05 μm or more and less than 0.15 μm.

The sulfide solid electrolyte of the thirteenth mode of the present embodiment is:
a sulfide solid electrolyte of the twelfth mode, of which the particle diameter (D90) of a cumulative volume of 90% is 0.10 μm or more and less than 10.0 μm.

The sulfide solid electrolyte of the fourteenth mode of the present embodiment is:
a sulfide solid electrolyte of the twelfth or thirteenth mode, of which the specific surface area is 20 to 50 m²/g.

The sulfide solid electrolyte of the fifteenth mode of the present embodiment is:
a sulfide solid electrolyte of any one of the twelfth to fourteenth mode, further containing 0.01 to 0.5% by mass of an oxygen atom-containing compound.

The sulfide solid electrolyte of the sixteenth mode of the present embodiment is:
a sulfide solid electrolyte of any one of the twelfth to fifteenth mode, in which the complexing agent is a nitrogen atom-containing compound.

The sulfide solid electrolyte of the seventeenth mode of the present embodiment is:
a sulfide solid electrolyte of the sixteenth mode, in which the nitrogen atom-containing compound is a compound having a tertiary amino group.

The sulfide solid electrolyte of the eighteenth mode of the present embodiment is:
a sulfide solid electrolyte mixture containing a sulfide solid electrolyte of any one of the twelfth to seventeenth modes, and the other sulfide solid electrolyte of which the particle diameter (D50) of a cumulative volume of 50% thereof in a laser diffraction scattering particle size distribution measuring method is 0.50 μm or more.

By combining the above-mentioned sulfide solid electrolyte and the other sulfide solid electrolyte having a larger particle diameter, the porosity, which is a problem of large particles, can be reduced. For example, in a separate layer, large particles having a smaller contact interface as compared with the electrode layer are used, which, however, may form voids. In the present embodiment, the above-mentioned sulfide solid electrolyte of fine particles is combined with the other sulfide solid electrolyte of large particles to reduce the porosity, and accordingly, the path between the ion conduction and electron conduction can be thereby bettered.

The sulfide solid electrolyte of the nineteenth mode of the present embodiment is:
a production method for a sulfide solid electrolyte mixture of the eighteenth mode, including mixing a sulfide solid electrolyte of any one of the twelfth to seventeenth modes, and the other sulfide solid electrolyte of which the particle diameter (D50) of a cumulative volume of 50% thereof in a laser diffraction scattering particle size distribution measuring method is 0.50 μm or more.

According to the present embodiment, the above-mentioned sulfide solid electrolyte mixture can be produced.

The sulfide solid electrolyte obtained according to the production method for a sulfide solid electrolyte of the present embodiment can have a small particle diameter to such a degree that preferably satisfies the particle diameter (D50) of a cumulative volume of 50% or the particle diameter (D90) of a cumulative volume of 90% mentioned above, and this can contain a small amount of a complexing agent and an oxygen atom-containing compound derived from the production process.

### [Sulfide Solid Electrolyte]

The “sulfide solid electrolyte” as referred to in this description means an electrolyte of keeping the solid state at 25° C. in a nitrogen atmosphere. The sulfide solid electrolyte in the present embodiment is a sulfide solid electrolyte containing a lithium element, a sulfur element, a phosphorus element, and a halogen element and having an ionic conductivity to be caused owing to the lithium element.

The “sulfide solid electrolyte” includes both the crystalline sulfide solid electrolyte having a crystal structure obtained according to the production method of the present embodiment and an amorphous sulfide solid electrolyte.

The crystalline sulfide solid electrolyte as referred to in this description is a material that is a sulfide solid electrolyte in which peaks derived from the solid electrolyte are observed in an X-ray diffraction pattern in the X-ray diffractometry, and the presence or absence of peaks derived from the raw materials of the sulfide solid electrolyte does not matter. That is, the crystalline sulfide solid electrolyte contains a crystal structure derived from the sulfide solid electrolyte, in which a part thereof may be a crystal structure derived from the sulfide solid electrolyte, or all of them may be a crystal structure derived from the sulfide solid electrolyte. The crystalline sulfide solid electrolyte may be one in which an amorphous sulfide solid electrolyte is contained in a part thereof so long as it has the X-ray diffraction pattern as mentioned above. In consequence, in the crystalline sulfide solid electrolyte, a so-called glass ceramics which is obtained by heating the amorphous sulfide solid electrolyte to a crystallization temperature or higher is contained.

The amorphous sulfide solid electrolyte as referred to in this description is a halo pattern in which any other peak than the peaks derived from the materials is not substantially observed in an X-ray diffraction pattern in the X-ray diffractometry, and it is meant that the presence or absence of peaks derived from the raw materials of the sulfide solid electrolyte does not matter.

### [Raw Material Inclusion]

The raw material inclusion for use in the present embodiment (hereinafter also simply referred to as a “raw material”) contains a lithium atom, a sulfur atom, a phosphorus atom and a halogen atom.

More specifically, the representative examples include compounds composed of at least two atoms selected from the aforementioned four kinds of atoms, such as lithium sulfide; lithium halides, e.g., lithium fluoride, lithium chloride, lithium bromide, and lithium iodide; phosphorus sulfides, e.g., diphosphorus trisulfide (P₂S₃) and diphosphorus pentasulfide (P₂S₅); phosphorus halides, e.g., various phosphorus fluorides (e.g., PF₃ and PF₅), various phosphorus chlorides (e.g., PCl₃, PCl₅, and P₂Cl₄), various phosphorus bromides (e.g., PBr₃ and PBr₅), and various phosphorus iodides (e.g., PI₃ and P₂I₄); and thiophosphoryl halides, e.g., thiophosphoryl fluoride (PSF₃), thiophosphoryl chloride (PSCl₃), thiophosphoryl bromide (PSBr₃), thiophosphoryl iodide (PSI₃), thiophosphoryl dichlorofluoride (PSCl₂F), and thiophosphoryl dibromofluoride (PSBr₂F); as well as halogen simple substances, such as fluorine (F₂), chlorine (Cl₂), bromine (Br₂), and iodine (I₂), with bromine (Br₂) and iodine (I₂) being preferred.

Examples that can be contained in the raw material other than those mentioned above include a compound containing at least one atom selected from the above-mentioned four kinds of atoms, and containing any other atoms than those four kinds of atoms, more specifically, lithium compounds, such as lithium oxide, lithium hydroxide, and lithium carbonate; alkali metal sulfides, such as sodium sulfide, potassium sulfide, rubidium sulfide, and cesium sulfide; metal sulfides, such as silicon sulfide, germanium sulfide, boron sulfide, gallium sulfide, tin sulfide (SnS, SnS₂), aluminum sulfide, and zinc sulfide; phosphate compounds, such as sodium phosphate and lithium phosphate; halide with an alkali metal other than lithium, such as sodium halides, e.g., sodium iodide, sodium fluoride, sodium chloride, and sodium bromide; metal halides, such as an aluminum halide, a silicon halide, a germanium halide, an arsenic halide, a selenium halide, a tin halogen, an antimony halide, a tellurium halide, and a bismuth halide; and phosphorus oxyhalides, such as phosphorus oxychloride (POCl₃) and phosphorus oxybromide (POBr₃).

Among the above, phosphorus sulfides, such as lithium sulfide, diphosphorus trifluoride (P₂S₃), and diphosphorus pentasulfide (P₂S₅); halogen simple substances, such as fluorine (F₂), chlorine (Cl₂), bromine (Br₂), and iodine (I₂); and lithium halides, such as lithium fluoride, lithium chloride, lithium bromide, and lithium iodide are preferred. In the case where an oxygen atom is introduced into the solid electrolyte, preferred are lithium oxide, lithium hydroxide and a phosphate compound such as lithium phosphate. Preferred examples of a combination of raw materials include a combination of lithium sulfide, diphosphorus pentasulfide, and a lithium halide; and a combination of lithium sulfide, diphosphorus pentasulfide, and a halogen simple substance, in which the lithium halide is preferably at least one selected from lithium bromide and lithium iodide, and the halogen simple substance is preferably bromine and iodine.

In the present embodiment, Li₃PS₄ that contains a PS₄ structure can be used as a part of the raw material. Specifically, Li₃PS₄ is prepared by production and this is used as the raw material.

The content of Li₃PS₄ to the total raw material is preferably 60 to 100 mol %, more preferably 65 to 90 mol %, even more preferably 70 to 80 mol %.

In the case where Li₃PS₄ and a halogen simple substance are used, the content of the halogen simple substance to Li₃PS₄ is preferably 1 to 50 mol %, more preferably 10 to 40 mol %, even more preferably 20 to 30 mol %, further more preferably 22 to 28 mol %.

The lithium sulfide which is used in the present embodiment is preferably a particle.

An average particle diameter (D₅₀) of the lithium sulfide particle is preferably 0.1 μm or more and 1000 μm or less, more preferably 0.5 μm or more and 100 μm or less, and still more preferably 1 μm or more and 20 μm or less. In this description, the average particle diameter (D₅₀) is a particle diameter to reach 50% of all the particles in sequential cumulation from the smallest particles in drawing the particle size distribution cumulative curve, and the volume distribution is concerned with an average particle diameter which can be, for example, measured with a laser diffraction/scattering particle size distribution measuring device. In addition, among the above-exemplified raw materials, the solid raw material is preferably a material having an average particle diameter of the same degree as that of the aforementioned lithium sulfide particle, namely a material having an average particle diameter falling within the same range as that of the aforementioned lithium sulfide particle is preferred.

In the case of using lithium sulfide, diphosphorus pentasulfide, and the lithium halide as the raw materials, from the viewpoint of obtaining higher chemical stability and a higher ionic conductivity, a proportion of lithium sulfide relative to the total of lithium sulfide and diphosphorus pentasulfide is preferably 70 to 80 mol %, more preferably 72 to 78 mol %, and still more preferably 74 to 78 mol %.

In the case of using lithium sulfide, diphosphorus pentasulfide, a lithium halide, and other raw materials to be optionally used, the content of lithium sulfide and diphosphorus pentasulfide relative to the total of the aforementioned raw materials is preferably 50 to 100 mol %, more preferably 55 to 85 mol %, and still more preferably 60 to 75 mol %.

In the case of using a combination of lithium bromide and lithium iodide as the lithium halide, from the viewpoint of enhancing the ionic conductivity, a proportion of lithium bromide relative to the total of lithium bromide and lithium iodide is preferably 1 to 99 mol %, more preferably 20 to 80 mol %, still more preferably 30 to 70 mol %, and especially preferably 40 to 60 mol %.

In the case of using not only a halogen simple substance but also lithium sulfide and diphosphorus pentasulfide as the raw materials, a proportion of the molar number of lithium sulfide excluding lithium sulfide having the same molar number as the molar number of the halogen simple substance relative to the total molar number of lithium sulfide and diphosphorus pentasulfide excluding lithium sulfide having the same molar number as the molar number of the halogen simple substance falls preferably within a range of 60 to 90%, more preferably within a range of 65 to 85%, still more preferably within a range of 68 to 82%, yet still more preferably within a range of 72 to 78%, and especially preferably within a range of 73 to 77%. This is because when the foregoing proportion falls within the aforementioned ranges, a higher ionic conductivity is obtained.

In addition, in the case of using lithium sulfide, diphosphorus pentasulfide, and a halogen simple substance, from the same viewpoint, the content of the halogen simple substance relative to the total amount of lithium sulfide, diphosphorus pentasulfide, and the halogen simple substance is preferably 1 to 50 mol %, more preferably 2 to 40 mol %, still more preferably 3 to 25 mol %, and yet still more preferably 3 to 15 mol %.

In the case of using lithium sulfide, diphosphorus pentasulfide, a halogen simple substance, and a lithium halide, the content (a mol %) of the halogen simple substance and the content (B mol %) of the lithium halide relative to the total of the aforementioned raw materials preferably satisfy the following expression (2), more preferably satisfy the following expression (3), still more preferably satisfy the following expression (4), and yet still more preferably satisfy the following expression (5).

2≤(2α+ß)≤100 (2)

4≤(2α+ß)≤80 (3)

6≤(2α+ß)≤50 (4)

6≤(2α+ß)≤30 (5)

In the case of using two halogen simple substances, when the molar number in the substance of the halogen element of one side is designated as A1, and the molar number in the substance of the halogen element of the other side is designated as A2, an A1/A2 ratio is preferably (1 to 99)/(99 to 1), more preferably 10/90 to 90/10, still more preferably 20/80 to 80/20, and yet still more preferably 30/70 to 70/30.

In the case where the two halogen simple substances are bromine and iodine, when the molar number of bromine is designated as B1, and the molar number of iodine is designated as B2, a B1/B2 ratio is preferably (1 to 99)/(99 to 1), more preferably 15/85 to 90/10, still more preferably 20/80 to 80/20, yet still more preferably 30/70 to 75/25, and especially preferably 35/65 to 75/25.

### [Complexing Agent]

In the present description, the complexing agent is a complexing agent that can form a complex containing Li₃PS₄ obtained from Li₂S and P₂S₅ favorably used as a raw material for the solid electrolyte and a halogen atom, preferably a complexing agent having an ability to form Li₃PS₄ and capable of forming a complex containing the formed Li₃PS₄ and a halogen atom.

Regarding the complexing agent for use in the present embodiment, one kind alone or two or more kinds can be used. As the complexing agent, generally used is one capable of forming a complex containing Li₃PS₄ and a halogen atom.

The amount of the complexing agent to be added in the case where the mixing in this embodiment is carried out is, from the viewpoint of efficiently forming the complex, preferably such that the molar ratio of the complexing agent to the total molar amount of the Li atom contained in the raw material inclusion is 0.5 or more and 7.0 or less, more preferably 0.6 or more and 5.5 or less, even more preferably 0.8 or more and 3.5 or less.

Any compound having the above-mentioned performance can be used as the complexing agent with no specific limitation in the present embodiment, and preferred is a compound having an atom especially having a high affinity for a lithium atom, for example, a hetero atom such as a nitrogen atom, an oxygen atom and a chlorine atom, and more preferred is a compound having a group containing these hetero atoms. This is because these hetero atoms and the group containing the hetero atoms can coordinate (bind to) lithium.

As the complexing agent, a nitrogen atom-containing compound is preferably used.

The hetero atom existing in the molecule of the complexing agent has a high affinity for a lithium atom, and is considered to bind to the raw materials that contain a lithium atom and a halogen atom such as Li₃PS₄ containing a PS₄ structure of the main backbone of the solid electrolyte produced in the present embodiment and a lithium halide, thereby having an ability to readily form a complex. Consequently, it is considered that, by mixing the raw materials and the complexing agent, the complex is formed and can be precipitated while keeping the dispersion condition of various components even in the precipitation step, and therefore an electrolyte precursor with a halogen atom more uniformly dispersed and fixed therein (hereinunder one obtained by mixing the raw material inclusion containing at least one selected from a lithium atom, a sulfur atom and a phosphorus atom and the complexing agent is also referred to as an electrolyte precursor) can be obtained, and as a result, a solid electrolyte having a high ionic conductivity can be obtained.

Consequently, the complexing agent preferably contains at least two hetero atoms in the molecule, more preferably has a group containing at least two hetero atoms in the molecule. Having a group containing at least two hetero atoms in the molecule, the complexing agent can bond the raw materials containing lithium and halogen such as Li₃PS₄ and a lithium halide via at least two hetero atoms in the molecule. Among the hetero atoms, a nitrogen atom is preferred, and an amino group is preferred as the group containing a nitrogen atom. Specifically, an amine compound is preferred as the complexing agent.

Any amine compound having an amino group in the molecule is employable with no specific limitation since it can promote complex formation, but a compound having at least two amino groups in the molecule is preferred. Having such a structure, the compound can bond the raw materials containing lithium and halogen such as Li₃PS₄ and a lithium halide via at least two nitrogen atoms in the molecule.

Examples of such amine compounds include amine compounds such as an aliphatic amine, an alicyclic amine, a heterocyclic amine and an aromatic amine, and one alone or plural kinds thereof can be used either singly or as combined.

More specifically, representative preferred examples of the aliphatic amine include an aliphatic diamine, such as an aliphatic primary diamine such as ethylenediamine, diaminopropane, and diaminobutane; an aliphatic secondary diamine such as N,N′-dimethylethylenediamine, N,N′-diethylethylenediamine, N,N′-dimethyldiaminopropane, and N,N′-diethyldiaminopropane; and an aliphatic tertiary diamine such as N,N,N′,N′-tetramethyldiaminomethane, N,N,N′,N′-tetramethylethylenediamine, N,N,N′,N′-tetraethylethylenediamine, N,N,N′,N′-tetramethyldiaminopropane, N,N,N′,N′-tetraethyldiaminopropane, N,N,N′,N′-tetramethyldiaminobutane, N,N,N′,N′-tetramethyldiaminpentane, and N,N,N′,N′-tetramethyldiaminohexane. Here, regarding exemplification in the present description, for example, diaminobutane indicates, unless otherwise specifically noted, all isomers including isomers relating to the position of the amino group such as 1,2-diaminobutane, 1,3-diaminobutane and 1,4-diaminobutane, and in addition thereto, linear or branched isomers and the like relating to butane.

The carbon number of the aliphatic amine is preferably 2 or more, more preferably 4 or more, even more preferably 6 or more, and the upper limit is 10 or less, more preferably 8 or less, even more preferably 7 or less. The carbon number of the aliphatic hydrocarbon group in the aliphatic amine is preferably 2 or more, and the upper limit is preferably 6 or less, more preferably 4 or less, even more preferably 3 or less.

Representative preferred examples of the alicyclic amine include an alicyclic diamine, such as an alicyclic primary diamine such as cyclopropanediamine, and cyclohexanediamine; an alicyclic secondary diamine such as bisaminomethylcyclohexane; and an alicyclic tertiary diamine such as N,N,N′,N′-tetramethyl-cyclohexanediamine, and bis(ethylmethylamino)cyclohexane. Representative preferred examples of the heterocyclic amine include a heterocyclic diamine, such as a heterocyclic primary diamine such as isophoronediamine; a heterocyclic secondary diamine such as piperazine, and dipiperidylpropane; and a heterocyclic tertiary diamine such as N,N-dimethylpiperazine, and bismethylpiperidylpropane.

The carbon number of the alicyclic amine and the heterocyclic amine is preferably 3 or more, more preferably 4 or more, and the upper limit is preferably 16 or less, more preferably 14 or less.

Representative preferred examples of the aromatic amine include an aromatic diamine, such as an aromatic primary diamine such as phenyldiamine, tolylenediamine, and naphthalenediamine; an aromatic secondary diamine such as N-methylphenylenediamine, N,N′-dimethylphenylenediamine, N,N′-bismethylphenylphenylenediamine, N,N′-dimethylnaphthalenediamine, N-naphthylethylenediamine; and an aromatic tertiary diamine such as N,N-dimethylphenylenediamine, N,N,N′,N′-tetramethylphenylenediamine, N,N,N′,N′-tetramethyldiaminodiphenylmethane, and N,N,N′,N′-tetramethylnaphthalenediamine.

The carbon number of the aromatic amine is preferably 6 or more, more preferably 7 or more, even more preferably 8 or more, and the upper limit is preferably 16 or less, more preferably 14 or less, even more preferably 12 or less.

The amine compound for use in the present embodiment can be substituted with a substituent such as an alkyl group, an alkenyl group, an alkoxy group, a hydroxy group or a cyano group, or a halogen atom.

Diamine are exemplified as specific examples, but needless-to-say, the amine compound for use in the present embodiment is not limited to diamines. Also employable here are imidazole compounds such as imidazole and methylimidazole, and polyamines having 3 or more amino groups such as diethylenetriamine, N,N′,N″-trimethyldiethylenetriamine, N,N,N′,N″,N″-pentamethyldiethylenetriamine, triethylenetetramine, N,N′-bis[(dimethylamino)ethyl]-N,N′-dimethylethylenediamine, hexamethylenetetramine, and tetraethylenepentamine.

Among the above, from the viewpoint of attaining a higher ionic conductivity, preferred as the complexing agent is a tertiary amine having a tertiary amino group as the amino group, more preferred is a tertiary diamine having two tertiary amino groups, even more preferred is a tertiary diamine having two tertiary amino groups at both ends, and further more preferred is an aliphatic tertiary diamine having tertiary amino groups at both ends. Of the above-mentioned amine compounds, as the aliphatic tertiary diamine having tertiary amino groups at both ends, preferred are tetramethylethylenediamine, tetraethylethylenediamine, tetramethyldiaminopropane and tetraethyldiaminopropane, and in consideration of easy availability, preferred are tetramethylethylenediamine and tetramethyldiaminopropane.

Compounds having any other group than an amino group, containing a nitrogen atom as a hetero atom, for example, those having a group such as a nitro group or an amide group can also provide the same effects as above.

### [Solvent]

In the present embodiment, a solvent can be further added in mixing the raw material and the complexing agent.

In forming a complex that is solid in the complexing agent that is liquid, when the complex can readily dissolve in the complexing agent, component separation may occur. Accordingly, by using a solvent that does not dissolve the complex, dissolution of the component in the electrolyte precursor can be prevented. In addition, by mixing the raw material and the complexing agent using a solvent, complex formation can be accelerated so that each main component can be made to exist evenly to obtain an electrolyte precursor where halogen elements are dispersed and fixed more and, as a result, an effect of obtaining a higher ionic conductivity can be more readily exhibited.

The production method for a solid electrolyte of the present embodiment is a so-called heterogeneous method, in which preferably the complex does not completely dissolve in the complexing agent that is liquid but can precipitate. By adding a solvent, complex dissolution can be controlled. In particular, halogen elements readily dissolve out from the complex, and by adding a solvent, a desired complex can be obtained while dissolution of halogen elements is retarded. As a result, via an electrolyte precursor where components such as halogens are dispersed, a crystalline solid electrolyte having a high ionic conductivity can be obtained.

The solvent having such properties is preferably a solvent having a solubility parameter of 10 or less. In the present description, the solubility parameter is described in various documents, for example, “Chemical Handbook” (issued in 2004, revised 5th edition, Maruzen Corporation), and is a value 6 ((cal/cm³)^{1/2}) calculated according to the following mathematical formula (1), and this is also referred to as a Hildebrand parameter, SP value.

[Math. 1]

δ=\sqrt{(ΔH−RT)/V} (1)

In the mathematical formula (1), ΔH is a molar heat generation, R is a vapor constant, T is a temperature, V is a molar volume.

By using a solvent having a solubility parameter of 10 or less, a halogen element and the raw materials containing a halogen element such as lithium halide, and further a component containing a halogen element that constitutes a co-crystal contained in the complex (for example, an aggregate to which a lithium halide and the complexing agent are bonded) can be made to be hardly soluble, relatively as compared to the above-mentioned complexing agent, and therefore halogen elements can be readily fixed in the complex so that in the resultant electrolyte precursor and further in the solid electrolyte halogen elements can exist in a well dispersed state, and a solid electrolyte having a high ionic conductivity can be readily obtained. Specifically, it is desirable that the solvent for use in the present embodiment does not dissolve the complex. From the same viewpoint, the solubility parameter of the solvent is preferably 9.5 or less, more preferably 9.0 or less, even more preferably 8.5 or less.

More specifically, a solvent heretofore widely used in solid electrolyte production can be employed as the solvent in the present embodiment. Examples thereof include a hydrocarbon solvent such as an aliphatic hydrocarbon solvent, an alicyclic hydrocarbon solvent and an aromatic hydrocarbon solvent; and an alcohol solvent, an ester solvent, an aldehyde solvent, a ketone solvent, an ether solvent in which one side has a carbon number of 4 or more, and a solvent containing a carbon atom, such as a solvent containing a carbon atom and a hetero atom element. Among these, it is preferable that one whose solubility parameter falls within the above range is appropriately selected and used.

More specifically, the solvent includes an aliphatic hydrocarbon solvent such as hexane (7.3), pentane (7.0), 2-ethylhexane, heptane (7.4), octane (7.5), decane, undecane, dodecane, and tridecane; an alicyclic hydrocarbon solvent such as cyclohexane (8.2), and methylcyclohexane; an aromatic hydrocarbon solvent such as benzene, toluene (8.8), xylene (8.8), mesithylene, ethylbenzene (8.8), tert-butylbenzene, trifluoromethylbenzene, nitrobenzene, chlorobenzene (9.5), chlorotoluene (8.8), and bromobenzene; an alcohol solvent such as ethanol (12.7), and butanol (11.4); an aldehyde solvent such as formaldehyde, acetaldehyde (10.3), and dimethylformamide (12.1); a ketone solvent such as acetone (9.9), and methyl ethyl ketone; an ether solvent such as dibutyl ether, cyclopentyl methyl ether (8.4), tert-butyl methyl ether, and anisole; and a solvent containing a carbon atom and a hetero atom such as acetonitrile (11.9), dimethyl sulfoxide, and carbon disulfide. In the above exemplification, the numeral value in the parenthesis is an SP value.

Among these solvents, preferred are an aliphatic hydrocarbon solvent, an alicyclic hydrocarbon solvent, an aromatic hydrocarbon solvent, and an ether solvent; and from the viewpoint of more stably attaining a high ionic conductivity, more preferred are heptane, cyclohexane, toluene, ethylbenzene, diethyl ether, diisopropyl ether, dibutyl ether, dimethoxyethane, cyclopentyl methyl ether, tert-butyl methyl ether, and anisole; even more preferred are diethyl ether, diisopropyl ether, and dibutyl ether; still more preferred are diisopropyl ether and dibutyl ether; and cyclohexane is especially preferred. The solvent for use in the present embodiment is an organic solvent of the above-mentioned exemplifications and is an organic solvent differing from the above-mentioned complexing agent. In the present embodiment, one alone or plural kinds of these solvents can be used either singly or as combined.

### [Mixing]

In the present embodiment, the raw material inclusion containing a lithium atom, a sulfur atom, a phosphorus atom and a halogen atom and a complexing agent are mixed to obtain an electrolyte precursor. The mode of mixing the raw materials and the complexing agent in the present embodiment can be in any of a solid or liquid condition, but in general, the raw materials contain a solid while the complexing agent is a liquid, and therefore, in general, these are mixed in such a manner that solid raw materials exist in a liquid complexing agent. In mixing the raw materials and a complexing agent, as needed, a solvent can be mixed in these. Hereinunder in the section of describing mixing of raw materials and a complexing agent, unless otherwise specifically noted, in addition, a solvent can be optionally mixed, as needed.

The method of mixing raw materials and a complexing agent is not specifically limited, and raw materials and a complexing agent may be put into an apparatus where raw materials and a complexing agent can be mixed, and mixed therein. For example, a complexing agent is fed in a tank, then a stirring blade is driven, and thereafter raw materials are gradually added. The mixing mode is preferable since a good state of mixing the raw materials can be provided, and the dispersibility of the raw materials can be thereby improved.

However, in the case where a halogen simple substance is used as a raw material, the raw material is not a solid in some cases. Specifically, under room temperature and normal pressure, fluorine and chlorine are gaseous while bromine is liquid. In such a case, for example, when the raw material is liquid, the solid raw material may be fed into the tank separately from other liquid raw materials but along with the complexing agent, while on the other hand, when the raw material is gaseous, it may be blown into a mixture of the complexing agent and the solid raw material.

The production method for a solid electrolyte of the present embodiment is characterized by mixing raw materials and a complexing agent, and the mixing operation can be performed with a stirring machine, or any other machine generally called a grinding machine used for the purpose of grinding solid raw materials, such as a medium-assisted grinding machine such as a ball mill and a bead mill, or both a stirring machine and a grinding machine can be used for the mixing. In the production method for a solid electrolyte of the present embodiment, a complex can be formed by merely mixing raw materials and a complexing agent, but for shortening the mixing time for obtaining a complex or for pulverization, a mixture of raw materials and a complexing agent can be ground with a grinding machine.

One specific example of the stirring machine is a mechanically stirring-type mixer equipped with a stirring blade in a tank. The mechanically stirring-type mixer includes a high-speed stirring type mixer and a double-arm type mixer. From the viewpoint of increasing the uniformity of the raw materials in the mixture of raw materials and a complexing agent to attain a higher ionic conductivity, a high-speed stirring type mixer is preferably used. The high-speed stirring type mixer includes a vertical axis rotating type mixer and a lateral axis rotating type mixer, and mixers of any of these types can be used.

Examples of a shape of the stirring blade which is used in the mechanically stirring-type mixer include an anchor type, a blade type, an arm type, a ribbon type, a multistage blade type, a double arm type, a shovel type, a twin-shaft blade type, a flat blade type, and a C type blade type. From the viewpoint of enhancing the uniformity of the raw materials in the raw material inclusion to attain a higher ionic conductivity, preferred are a shovel type, a flat blade type, and a C type blade type. In a mechanically stirring-type mixer, a circulation line for once discharging the materials to be stirred out of the mixer and then again returned back them to the inside of the mixer can be arranged. With that, raw materials having a heavy specific gravity such as lithium halide can be stirred without precipitation and accumulation, and more uniform mixing can be thereby attained.

The site where the circulation line is arranged is not specifically limited, but is preferably so arranged that the materials are discharged out from the bottom of the mixer and returned back to the top of the mixer. In that manner, raw materials susceptible to precipitation become easy to uniformly stir on convection by circulation. Further, the returning mouth is preferably positioned below the liquid level of the materials being stirred. In that manner, the materials being stirred can be prevented from splashing to adhere to the inner surface of the wall of the mixer.

The temperature condition in mixing raw materials and a complexing agent is not specifically limited, and can be, for example, −30 to 100° C., preferably −10 to 50° C., more preferably around room temperature (23° C.) (for example, room temperature±5° C. or so). The mixing time is 0.1 to 150 hours or so, but is, from the viewpoint of more uniformly mixing the materials to attain a higher ionic conductivity, preferably 1 to 120 hours, more preferably 4 to 100 hours, even more preferably 8 to 80 hours.

By mixing raw materials and a complexing agent, owing to an action of the lithium element, the sulfur element, the phosphorus element, and the halogen element, all of which are contained in the raw materials, with the complexing agent, a complex in which these elements are bound directly with each other via and/or not via the complexing agent is obtained. That is, in the production method for a solid electrolyte of the present embodiment, the complex obtained through mixing of the raw materials and the complexing agent is constituted of the complexing agent, the lithium element, the sulfur element, the phosphorus element, and the halogen element. In the present embodiment, the resultant complex is not completely dissolved in the complexing agent that is a liquid, but is generally solid, and therefore in the present embodiment, the complex and a suspension containing the complex suspended in a solvent optionally added are obtained. In consequence, the production method for the solid electrolyte of the present embodiment is corresponding to a heterogeneous system in a so-called liquid-phase method.

### [Removal of Complexing Agent]

In the production method for a sulfide solid electrolyte of the present embodiment, the complexing agent is removed from the electrolyte precursor prepared in the manner as above to obtain a complex degradate. Accordingly, a powder of a complex degradate is obtained.

The removal of the complexing agent can be attained at a temperature in accordance with the complexing agent to remain in the complex, and the kind of the solvent. The temperature condition in removing the complexing agent is generally 5 to 100° C., preferably 10 to 85° C., more preferably 15 to 70° C., even more preferably around room temperature (23° C.) (for example, room temperature 5° C. or so). The complexing agent and the solvent can be evaporated by drying under reduced pressure (vacuum drying), using a vacuum pump.

Different from the complexing agent, the solvent can hardly be taken in the complex, and therefore the solvent taken in the complex is generally 3% by mass or less, preferably 2% by mass or less, more preferably 1% by mass or less.

The drying can be performed by filtration using a glass filer, solid-liquid separation through decantation, or solid-liquid separation with a centrifuge or the like. In the present embodiment, after performing the solid-liquid separation, the drying can be performed under the aforementioned temperature condition.

Specifically, for the solid-liquid separation, decantation in which the suspension is transferred into a container, and after solid precipitation, the complexing agent and the optionally-added solvent that are to be supernatants are removed, or filtration with a glass filter having a pore size of, for example, about 10 to 200 μm, and preferably 20 to 150 μm, is easy.

The complex is constituted of the complexing agent, a lithium element, a sulfur element, a phosphorus element, and a halogen element, and is characterized in that, on the X-ray diffraction pattern in the X-ray diffractometry, peaks different from raw materials-derived peaks are observed, and preferably the complex contains a co-crystal composed of the complexing agent, a lithium element, a sulfur element, a phosphorus element, and a halogen element. By merely mixing raw materials, peaks derived from the raw materials are only observed, but by mixing raw materials and the complexing agent, peaks different from the raw materials-derived peaks are observed, and from this, it is known that the complex (co-crystal) has a structure obviously different from the raw materials themselves contained in the raw materials.

### [Heating of Complex Degradate]

In the production method for a sulfide solid electrolyte of the present embodiment, the complex degradate is heated to obtain a crystalline solid electrolyte. By heating the complex degradate, the complexing agent in the complex degradate is removed to obtain a crystalline solid electrolyte containing a lithium element, a sulfur element, a phosphorus element and a halogen element. Here, the fact that the complexing agent is removed from the complex degradate is obvious from the results of the X-ray diffraction pattern and gas chromatography which confirm that the complexing agent form a co-crystal with an electrolyte precursor. In addition to this, this is supported by the fact that the X-ray diffraction pattern of the crystalline complex degradate obtained by removal of the complexing agent achieved by heating the complex degradate is the same as that of the solid electrolyte obtained according to a conventional method not using a complexing agent.

In the production method of the present embodiment, the complex degradate is heated to remove the complexing agent from the complex degradate, thereby obtaining a sulfide solid electrolyte, and the amount of the complexing agent in the solid electrolyte is preferably as small as possible. However, the complexing agent can be contained to an extent that the performance of the complex degradate is not impaired. The content of the complexing agent in the complex degradate can be typically 10% by mass or less, and it is preferably 5% by mass or less, more preferably 3% by mass or less, and still more preferably 1% by mass or less.

The heating temperature for the complex degradate may be determined depending on the structure of the crystalline solid electrolyte. Specifically, the heating temperature may be determined by subjecting the complex degradate to differential thermal analysis (DTA) with a differential thermal analysis device (DTA device) under a temperature rise condition of 10° C./min and adjusting the temperature to a range of preferably 5° C. or higher, more preferably 10° C. or higher, and still more preferably 20° C. or higher starting from a peak top temperature of the exothermic peak detected on the lowermost temperature side. Although an upper limit thereof is not particularly restricted, it may be set to a temperature of about 40° C. or lower. By regulating the heating temperature to such a temperature range, the crystalline solid electrolyte is obtained more efficiently and surely. Although the heating temperature for obtaining the crystalline solid electrolyte cannot be unequivocally prescribed because it varies with the structure of the resultant crystalline solid electrolyte, in general, it is preferably 130° C. or higher, more preferably 135° C. or higher, and still more preferably 140° C. or higher. Although an upper limit of the heating temperature is not particularly limited, it is preferably 300° C. or lower, more preferably 280° C. or lower, and still more preferably 250° C. or lower.

Although the heating time is not particularly limited so long as it is a time for which the desired amorphous solid electrolyte and crystalline solid electrolyte are obtained, for example, it is preferably 1 minute or more, more preferably 10 minutes or more, still more preferably 30 minutes or more, and yet still more preferably 1 hour or more. In addition, though an upper limit of the heating time is not particularly restricted, it is preferably 24 hours or less, more preferably 10 hours or less, still more preferably 5 hours or less, and yet still more preferably 3 hours or less.

It is preferred that the heating is performed in an inert gas atmosphere (for example, a nitrogen atmosphere and an argon atmosphere) or in a reduced pressure atmosphere (especially, in vacuo). This is because deterioration (for example, oxidation) of the crystalline solid electrolyte can be prevented from occurring. Although a method for heating is not particularly limited, for example, a method of using a hot plate, a vacuum heating device, an argon gas atmosphere furnace, a firing furnace or the like can be adopted. In addition, industrially, a lateral dryer, a lateral vibration fluid dryer or the like provided with a heating means and a feed mechanism may be selected according to the heating treatment amount.

### [Mechanical Treatment]

In the production method for a solid electrolyte of the present embodiment, a mechanical treatment with an integrated energy amount of 10 Wh/kg or more and less than 500 Wh/kg is applied to the crystalline complex degradate obtained in the manner as above, thereby to pulverize it to obtain a pulverized product. When the integrated energy amount in the mechanical treatment is less than 10 Wh/kg, the oil absorption of the resultant sulfide solid electrolyte increases, but when it is 500 Wh/kg or more, the specific surface area of the resultant sulfide solid electrolyte reduces. The cumulative energy amount is preferably 20 Wh/kg or more and 420 Wh/kg or less, more preferably 40 Wh/kg or more and 380 Wh/kg or less.

The integrated energy is determined as follows.

### (How to Determine Integrated Energy)

Integrated energy E (unit: Wh/kg) is calculated according to the following formula, in which P₀ (unit: W) represents a lost motion energy average of each machine in the case not containing a crystalline complex degradate, P (unit: W) represents an instantaneous power average needed in treating the crystalline complex degradate with each machine, t (unit: h) represents a total treatment time, and M (unit: kg) represents a total weight of the crystalline complex degradate to be treated.

E=(P−P₀)×t/M

The mechanical treatment method for the crystalline complex degradate can be a method using an apparatus such as a grinding machine or a stirring machine.

Examples of the stirring machine include a mechanical stirring mixer equipped with a stirring blade inside the tank. The mechanical stirring mixer includes a high-speed stirring mixer and a double-arm type mixer. Any of these types can be employed here, but from the viewpoint of more readily preparing a desired morphology, a high-speed stirring mixer is preferred. More specifically, the high-speed stirring mixer includes a vertical axis rotating mixer, a lateral axis rotating mixer, a high-speed revolving thin-film stirrer and a high-speed shearing stirrer. Above all, from the viewpoint of more readily preparing a desired morphology, a high-speed revolving thin-film stirrer (also referred to as “thin-film revolving high-speed mixer”) is preferred.

As the grinding machine, there is mentioned a grinding machine equipped with a rotor capable of stirring the solid electrolyte at least having a volume-based average particle diameter, as measured according to a laser diffraction particle size distribution measuring method, of 1 μm or more and having a specific surface area, as measured according to a BET method, of 20 m²/g or more.

The peripheral speed of the rotor can vary, for example, depending on the particle diameter, the material and the amount used of the media for use in the pulverizing machine, and therefore cannot be indiscriminately defined. For example, in the case of a device not using a grinding medium such as balls or beads like a high-speed revolving thin-film stirrer, pulverization can mainly occur even at a relatively high peripheral speed, and granulation can occur hardly. On the other hand, in the case of an apparatus using a grinding medium such as balls or beads, pulverization can be attained at a low peripheral speed as described above.

As a more specific device of a grinding machine, for example, there can be mentioned a medium-assisted grinding machine. The medium-assisted grinding machine can be grouped into a vessel driving grinding machine and a medium-stirring grinding machine.

The vessel driving grinding machine includes a stirring tank, a grinding tank, or a combination thereof such as a ball mill and bead mill. As a ball mill and a bead mill, any type is employable including a rotation type, a tumbler type, a vibration type and a planetary type.

The medium-stirring grinding machine includes various grinding machines, such as an impact grinder such as a cutter mill, a hammer mill and a pin mill; a tower grinder such as a tower mill; a stirrer tank grinder such as an attritor, an Aquamizer, and a sand grinder; a circulation tank grinder such as a Viscomill, and a pearl mill; a flow tube grinder; an annular grinder such as a co-ball mill; and a continuous dynamic grinder.

In the mechanical treatment for the crystalline complex degradate, from the viewpoint of more readily preparing a desired morphology, a vessel driving grinding machine is preferred. Above all, a bead mill and a ball mill are preferred. The vessel driving grinding machine such as a bead mill and a ball mill is equipped with a rotor capable of stirring the crystalline complex degradate, a stirring tank for containing the crystalline complex degradate, and a container of a grinding tank. By controlling the peripheral speed of the rotor, the integrated energy amount to be applied in the mechanical treatment can be readily controlled.

The grain size of the medium such as a bead or a ball to be used in the bead mill, the ball mill or the like can be appropriately determined in consideration of the desired morphology and also the kind, the scale and the like of the apparatus to be used, but in general, it is preferably 0.01 mm or more, more preferably 0.015 mm or more, even more preferably 0.02 mm or more, further more preferably 0.04 mm or more, and the upper limit is preferably 3 mm or less, more preferably 2 mm or less, even more preferably 1 mm or less, further more preferably 0.8 mm or less.

Examples of the material of the medium include metals such as stainless, chrome steel, and tungsten carbide; ceramics such as zirconia and silicon nitride; and minerals such as agate.

The treatment time for mechanical treatment can be appropriately determined in consideration of the desired morphology and also the kind, the scale and the like of the apparatus to be used, but in general, it is preferably 5 seconds or more, more preferably 30 seconds or more, even more preferably 3 minutes or more, further more preferably 15 minutes or more, and the upper limit is preferably 5 hours or less, more preferably 3 hours or less, even more preferably 2 hours or less, further more preferably 1.5 hours or less.

The peripheral speed of the rotor in mechanical treatment (rotation speed in the apparatus such as a bead mill and ball mill) can be appropriately determined in consideration of the desired morphology and also the kind, the scale and the like of the apparatus to be used, but in general, it is preferably 0.5 m/sec or more, more preferably 1 m/sec or more, even more preferably 2 m/sec or more, further more preferably 3 m/sec or more, and the upper limit is preferably 55 m/sec or less, more preferably 40 m/sec or less, even more preferably 25 m/sec or less, further more preferably 15 m/sec or less. The peripheral speed can be the same during the process but can change on the way.

Mechanical treatment can be performed in a solvent. As the solvent, from the viewpoint of attaining the desired average particle diameter and specific surface area and also attaining a high ionic conductivity more stably, preferred are an aliphatic hydrocarbon solvent, an alicyclic hydrocarbon solvent, an aromatic hydrocarbon solvent and an ether solvent. More preferred are heptane, cyclohexane, toluene, ethylbenzene, diethyl ether, diisopropyl ether, dibutyl ether, dimethoxyethane, cyclopentyl methyl ether, tert-butyl methyl ether, and anisole, even more preferred are heptane, toluene and ethylbenzene, and further more preferred are heptane and toluene.

The solvent for use in mechanical treatment is preferably an oxygen atom-containing compound, more preferably an ether compound, and also preferably the solvent contains a hydrocarbon compound.

More specifically, the solvent preferably contains 50 to 99.5% by mass of a hydrocarbon compound, 0.5 to 50% by mass of an oxygen atom-containing compound, more preferably 70 to 95% by mass of a hydrocarbon compound and 5.0 to 30% by mass of an oxygen atom-containing compound, even more preferably 80 to 92% by mass of a hydrocarbon compound and 8.0 to 20% by mass of an oxygen atom-containing compound

The amount to be used of the solvent is preferably such that the content of the crystalline complex degradate relative to the total amount of the crystalline complex degradate and the solvent is 1% by mass or more, more preferably 3% by mass or more, even more preferably 8% by mass or more, and the upper limit is preferably 30% by mass or less, more preferably 23% by mass or less, even more preferably 18% by mass or less.

In the production method of the present embodiment, heat treatment for crystallization is in principle unnecessary for the pulverized product after mechanical treatment of the crystalline complex degradate. However, though the energy for mechanical treatment is relatively small, a part or all of the crystalline complex degradate may be vitrified (amorphized), as the case may be. In that case, the crystalline complex degradate may be heated for recrystallization. Specifically, the present embodiment can include heating the pulverized product after mechanical treatment of the crystalline complex degradate.

The crystalline solid electrolyte obtained in the production method of the present embodiment has a morphology such that chemically stable primary particles have aggregated, different from primary particles prepared by grinding coarse particles to have new surfaces exposed out, and therefore can be relatively suppressed from granulation in crystallization.

The method of removing the solvent from the pulverized product can be the same as the method of removing the complexing agent from the electrolyte precursor, but from the viewpoint of maintaining the particle size distribution, preferably, the solvent is evaporated away by reduced-pressure drying (vacuum drying) using a vacuum pump or the like at room temperature (23° C.) or so (for example, room temperature±5° C. or so).

### [Sulfide Solid Electrolyte]

The sulfide solid electrolyte obtained according to the production method for a sulfide solid electrolyte of the present embodiment contains a lithium element, a sulfur element, a phosphorus element and a halogen element, and preferred examples thereof include a solid electrolyte composed of lithium sulfide, phosphorus sulfide and lithium halide, such as Li₂S—P₂S₅—LiI, Li₂S—P₂S₅—LiCl, Li₂S—P₂S₅—LiBr, and Li₂S—P₂S₅—LiI—LiBr; and a solid electrolyte further containing other element such as an oxygen element and a silicon element, such as Li₂S—P₂S₅—Li₂O—LiI, and Li₂S—SiS₂—P₂S₅—LiI. From the viewpoint of attaining a higher ionic conductivity, preferred is a solid electrolyte composed of lithium sulfide, phosphorus sulfide and lithium halide, such as Li₂S—P₂S₅—LiI, Li₂S—P₂S₅—LiCl, Li₂S—P₂S₅—LiBr, and Li₂S—P₂S₅—LiI—LiBr.

The kind of the element constituting the sulfide solid electrolyte can be identified, for example, with an ICP emission spectrophotometer.

The crystalline solid electrolyte obtained according to the production method for a sulfide solid electrolyte of the present embodiment may be a so-called glass ceramics which is obtained by heating the amorphous solid electrolyte at the crystallization temperature or higher, and examples of a crystal structure thereof include an Li₃PS₄ crystal structure, an Li₄P₂S₆ crystal structure, an Li₇PS₆ crystal structure, an Li₇P₃S₁₁ crystal structure, and a crystal structure having peaks at around 2θ=20.2° and 23.6° (for example, JP 2013-16423 A).

In addition, examples thereof also include an Li₄₋ₓGe₁₋ₓPₓS₄-based thio-LISICON Region II-type crystal structure (see Kanno, et al., Journal of The Electrochemical Society, 148 (7) A742-746 (2001)) and a crystal structure similar to the Li₄₋ₓGe₁₋ₓPₓS₄-based thio-LISICON Region II-type crystal structure (see Solid State Ionics, 177 (2006), 2721-2725). Among those mentioned above, a crystal structure of the crystalline solid electrolyte obtained in the production method for a sulfide solid electrolyte of the present embodiment is preferably a thio-LISICON Region II-type crystal structure from the standpoint that a higher ionic conductivity is obtained. Here, the “thio-LISICON Region II-type crystal structure” expresses any one of an Li₄₋ₓGe₁₋ₓPₓS₄-based thio-LISICON Region II-type crystal structure and a crystal structure similar to the Li₄₋ₓGe₁₋ₓPₓS₄-based thio-LISICON Region II-type crystal structure.

In addition, though the crystalline electrolyte obtained in the production method of the present production method may be one containing the aforementioned thio-LISICON Region II-type crystal structure or may be one containing the thio-LISICON Region II-type crystal structure as a main crystal, it is preferably one containing the thio-LISICON Region II-type crystal structure as a main crystal from the viewpoint of obtaining a higher ionic conductivity. In this description, the wording “containing as a main crystal” means that a proportion of the crystal structure serving as an object in the crystal structure is 80% or more, and it is preferably 90% or more, and more preferably 95% or more. In addition, from the viewpoint of obtaining a higher ionic conductivity, the crystalline solid electrolyte obtained in the production method of the present embodiment is preferably one not containing crystalline Li₃PS₄ (ß-Li₃PS₄).

In the X-ray diffractometry using a CuKα ray, the Li₃PS₄ crystal structure gives diffraction peaks, for example, at around 2θ=17.5°, 18.3°, 26.1°, 27.3°, and 30.0°; the Li₄P₂S₆ crystal structure gives diffraction peaks, for example, at around 2θ=16.9°, 27.1°, and 32.5°; the Li₇PS₆ crystal structure gives diffraction peaks, for example, at around 2θ=15.3°, 25.2°, 29.6°, and 31.00; the Li₇P₃S₁₁ crystal structure gives diffraction peaks, for example, at around 2θ=17.8°, 18.5°, 19.7°, 21.8°, 23.7°, 25.9°, 29.6°, and 30.00; the Li₄₋ₓGe₁₋ₓPₓS₄-based thio-LISICON Region II-type crystal structure gives diffraction peaks, for example, at around 2θ=20.1°, 23.9°, and 29.50; and the crystal structure similar to the Li₄₋ₓGe₁₋ₓPₓS₄-based thio-LISICON Region II-type crystal structure gives diffraction peaks, for example, at around 2θ=20.2 and 23.6°. The position of these peaks may vary within a range of 0.5°.

The crystal structure having the above-mentioned structural backbone of Li₇PS₆ in which a part of P is substituted with Si to have a compositional formula Li₇₋ₓP_{1-y}Si_{y}S₆ or Li₇₊ₓP_{1-y}Si_{y}S₆ (x represents −0.6 to 0.6, y represents 0.1 to 0.6) is a cubic crystal or a rhombic crystal, preferably a cubic crystal having peaks mainly appearing at the position of 2θ=15.5°, 18.0°, 25.0°, 30.0°, 31.4°, 45.3°, 47.0°, and 52.0° in X-ray diffractometry using a CuKα ray. The crystal structure shown by the above-mentioned compositional formula Li_{7-x-2y}PS_{6-x-y}Clₓ (0.85≤x≤1.7, 0<y≤−0.25x+0.5) is preferably a cubic crystal having peaks mainly appearing at the position of 2θ=15.5°, 18.0°, 25.0°, 30.0°, 31.4°, 45.3°, 47.0°, and 52.0° in X-ray diffractometry using a CuKα ray. The crystal structure shown by the above-mentioned compositional formula Li₇₋ₓPS₆₋ₓHaₓ (Ha represents Cl or Br, x is preferably 0.2 to 1.8) is preferably a cubic crystal having peaks mainly appearing at the position of 2θ=15.5°, 18.0°, 25.0°, 30.0°, 31.4°, 45.3°, 47.0°, and 52.0° in X-ray diffractometry using a CuKα ray.

The position of these peaks may vary within a range of ±0.5°.

In the case where the sulfide solid electrolyte obtained in the production method for a sulfide solid electrolyte of the present embodiment has at least Li₂S—P₂S₅, the proportion of lithium sulfide relative to the total of lithium sulfide and diphosphorus pentasulfide is, from the viewpoint of attaining higher chemical stability and a higher ionic conductivity, preferably 70 to 80 mol %, more preferably 72 to 78 mol %, even more preferably 74 to 78 mol %.

Also in the case where the sulfide solid electrolyte contains lithium sulfide, diphosphorus pentasulfide, lithium halide and other optional raw material, the content of lithium sulfide and diphosphorus pentasulfide relative to the total of these is preferably 50 to 100 mol %, more preferably 55 to 85 mol %, even more preferably 60 to 75 mol %.

In the case where the sulfide solid electrolyte contains lithium bromide and lithium iodide as lithium halide, the proportion of lithium bromide to the total of lithium bromide and lithium iodide is, from the viewpoint of improving the ionic conductivity, preferably 1 to 99 mol %, more preferably 20 to 80 mol %, even more preferably 30 to 70 mol %, further more preferably 40 to 60 mol %.

In the sulfide solid electrolyte obtained in the production method for a solid electrolyte of the present embodiment, the blend ratio (molar ratio) of lithium element, sulfur element, phosphorus element and halogen element is preferably 1.0 to 1.8/1.0 to 2.0/0.1 to 0.8/0.01 to 0.6, more preferably 1.1 to 1.7/1.2 to 1.8/0.2 to 0.6/0.05 to 0.5, even more preferably 1.2 to 1.6/1.3 to 1.7/0.25 to 0.5/0.08 to 0.4. In the case where bromine and iodine are used together as halogen element, the blend ratio (molar ratio) of lithium element, sulfur element, phosphorus element, bromine and iodine is preferably 1.0 to 1.8/1.0 to 2.0/0.1 to 0.8/0.01 to 0.3/0.01 to 0.3, more preferably 1.1 to 1.7/1.2 to 1.8/0.2 to 0.6/0.02 to 0.25/0.02 to 0.25, even more preferably 1.2 to 1.6/1.3 to 1.7/0.25 to 0.5/0.03 to 0.2/0.03 to 0.2, further more preferably 1.35 to 1.45/1.4 to 1.7/0.3 to 0.45/0.04 to 0.18/0.04 to 0.18. When the blend ratio (molar ratio) of lithium element, sulfur element, phosphorus element and halogen element falls within the above range, a solid electrolyte having a thio-LISICON Region II-type crystal structure to be mentioned later and having a higher ionic conductivity can be readily produced.

The sulfide solid electrolyte obtained in the production method of the present embodiment contains a lithium atom, a sulfur atom, a phosphorus atom, a halogen atom and 0.01 to 1.0% by mass of a complexing agent, of which the particle diameter (D50) of a cumulative volume of 50% in a laser diffraction scattering particle size distribution measuring method is 0.10 μm or more and less than 0.50 μm, and of which the particle diameter (D10) of a cumulative volume of 10% is 0.05 μm or more and less than 0.15 μm.

A preferred range of the particle diameter (D10) of a cumulative volume of 10% in a laser diffraction scattering particle size distribution measuring method of the sulfide solid electrolyte of the present embodiment, the particle diameter (D50) of a cumulative volume of 50% thereof and the particle diameter (D90) of a cumulative volume of 90% thereof is as mentioned below.

The particle diameter (D10) of a cumulative volume of 10% of the sulfide solid electrolyte is preferably 0.05 μm or more and 0.12 μm or less, more preferably 0.06 μm or more and 0.10 μm or less.

The particle diameter (D50) of a cumulative volume of 50% of the sulfide solid electrolyte is preferably 0.10 μm or more and 0.30 μm or less, more preferably 0.11 μm or more and 0.25 μm or less, further more preferably 0.11 μm or more and 0.20 μm or less.

The particle diameter (D90) of a cumulative volume of 90% of the sulfide solid electrolyte is preferably 0.10 μm or more and less than 10.0 μm, more preferably 0.40 μm or more and 7.00 μm or less, even more preferably 0.60 μm or more and 3.00 μm or less.

Here, the particle diameter (D50) of a cumulative volume of 50% is a particle diameter to reach 50% of all the particles in sequential cumulation from particles with the smallest particle size in drawing the particle size distribution cumulative curve, and the same applies to the particle diameter (D10) of a cumulative volume of 10% and particle diameter (D90) of a cumulative volume of 90%.

Further, the sulfide solid electrolyte of the present embodiment has a specific surface area as measured by a BET method (in the present description, it may be simply referred to as a “specific surface area”) of preferably 20 to 50 m²/g, more preferably 25 to 40 m²/g.

As a specific measuring method for the specific surface area, referred to is the method used in Examples.

In the sulfide solid electrolyte of the present embodiment, the above-mentioned complex agent remains, as derived from the production method. Accordingly, for example, in the case where a nitrogen atom-containing compound such as a compound having a tertiary amino group is used as the complexing agent, the sulfide solid electrolyte contains the nitrogen atom-containing compound, and the content thereof is, for example, 0.01 to 1.0% by mass.

In the sulfide solid electrolyte of the present embodiment, the above-mentioned solvent used in pulverization remains, as derived from the production method. Accordingly, for example, in the case where an oxygen atom-containing compound is used as the solvent, the sulfide solid electrolyte contains the oxygen atom-containing compound in an amount of 0.01 to 0.5% by mass.

### [Sulfide Solid Electrolyte Mixture]

The sulfide solid electrolyte mixture of the present embodiment contains the above-mentioned sulfide solid electrolyte and any other sulfide solid electrolyte of which the particle diameter (D50) of a cumulative volume of 50% in a laser diffraction scattering particle size distribution measuring method is 0.50 μm or more.

The other sulfide solid electrolyte is not specifically limited. For this, for example, the complex degradate and the crystalline complex degradate in the production method for a solid electrolyte of the present embodiment mentioned above can be used.

### EXAMPLES

Next, the present invention is described specifically with reference to Examples, but it should be construed that the present invention is by no means restricted by these Examples.

The particle diameter, the amount of oil absorption, the specific surface area, and the amount of the remaining complexing agent in Examples 1 to 3 and Comparative Examples 1 to 2 were measured as follows.

### (Measurement of Particle Diameter)

The particle diameter (D10) of a cumulative volume of 10%, the particle diameter (D50) of a cumulative volume of 50%, and the particle diameter (D90) of a cumulative volume of 90% were determined from the particle size distribution cumulative curve obtained as follows.

This was measured with a laser diffraction/scattering particle size distribution measuring apparatus (LA-950V2 Model LA-950S2, by HORIBA, Ltd.).

Dewatered toluene (by FUJIFILM Wako Pure Chemical Corporation, special grade chemical) was used as a dispersion medium. 50 mL of the dispersion medium was injected into a flow cell of the apparatus and circulated therein, and then a subject to be measured is added and ultrasonically processed, and thereafter the particle size distribution thereof was measured.

### (Measurement of Oil Absorption Amount)

One g of the crystalline solid electrolyte obtained in Examples and Comparative Examples was taken as a sample. In an agate mortar, one drop of butyl butyrate was added to the sample, using a dropper, and stirred with a spatula. This operation was repeated until the sample became pasty, and the total amount of butyl butyrate added was referred to as an oil absorption amount (mug).

### (Specific Surface Area)

This was measured in a BET flow method (three-point method) using a nitrogen gas as the adsorbate, according to JIS R 1626:1996.

### (Amount of Remaining Complexing Agent)

This was measured with a gas chromatograph (Model 6890, by Agilent Corporation).

### Example 1

13.19 g of lithium sulfide, 21.26 g of diphosphorus pentasulfide, 4.15 g of lithium bromide and 6.40 g of lithium iodide were put into a 1-liter reactor equipped with a stirring blade, in a nitrogen atmosphere. 100 mL of tetramethylethylenediamine (TMEDA) as a complexing agent, and 800 mL of cyclohexane as a solvent were added thereto, and mixed by stirring with the stirring blade. 456 g of zirconia balls (diameter: 0.5 mmφ) (bead filling rate to the grinding room: 80%) were fed into a circulation operable bead mill (trade name: “Labo Star Mini LMZ015”, by Ashizawa Finetech Ltd.). While kept circulated between the reactor and the grinding room under the condition of a pump flow rate of 550 mL/min, a peripheral speed of 8 m/s and a mill jacket temperature of 20° C., the mixture was ground for 60 minutes to obtain a complex slurry. Next, the resultant slurry was immediately dried at room temperature (23° C.) in vacuum to obtain a powdery complex. The resultant complex was dried at 110° C. for 6 hours under reduced pressure to obtain an amorphous complex degradate. Next, this was heated at 160° C. under reduced pressure for 2 hours to obtain a crystalline complex degradate.

The resultant complex degradate was measured by powdery XRD diffractometry. The results are shown in FIG. 6.

Next, 80 g of the crystalline complex degradate obtained in the above was put into a reactor equipped with a stirring blade, 740 mL of heptane and 110 mL of diisopropyl ether (DiPE) were added, and stirred for 10 minutes to obtain a slurry. Using a circulation operable bead mill (trade name: “Labo Star Mini LMZ015”, by Ashizawa Finetech Ltd.), the slurry was pulverized for 30 minutes, while kept circulated under predetermined conditions (bead diameter: 0.3 mmφ, amount of beads used: 456 g (bead filling rate to the grinding room: 80%), pump flow rate: 400 mL/min, peripheral speed: 3 m/s).

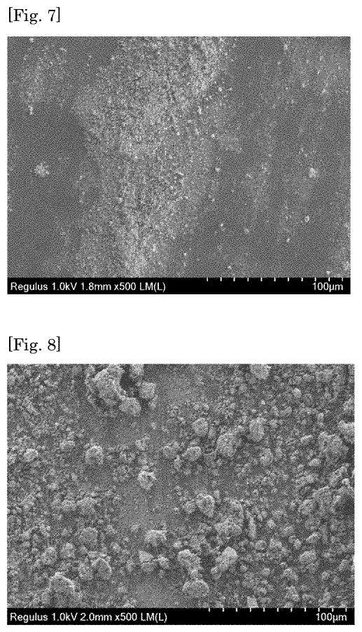

Further, the pulverized slurry was dried in vacuum at room temperature (23° C.) to obtain a pulverized solid electrolyte powder. The resultant solid electrolyte powder was photographed with a scanning microscope (SEM) (FIG. 7).

### Example 2

A crystalline complex degradate was prepared in the same manner as in Example 1.

Next, 100 g of the crystalline complex degradate prepared in the above was put into a reactor equipped with a stirring blade, 2144 mL of heptane and 138 mL of diisopropyl ether (DiPE) were added and stirred for 10 minutes to obtain a slurry. Using a circulation operable bead mill (trade name: “MAX Nano Getter”, by Ashizawa Finetech Ltd.), the slurry was pulverized for 3 minutes in a mode of pass operation under predetermined conditions (bead diameter: 0.05 mmφ, amount of beads used: 1573 g (bead filling rate to the grinding room: 65%), pump flow rate: 1000 mL/min, peripheral speed: 6 m/s).

Further, the pulverized slurry was dried in vacuum at room temperature (23° C.) to obtain a pulverized solid electrolyte powder.

### Example 3

A crystalline complex degradate was obtained in the same manner as in Example 1.

Next, 200 g of the crystalline complex degradate obtained in the above was put into a reactor equipped with a stirring blade. Using a stirring machine, trade name: “Super Mixer Piccolo”, by Kawata Mfg. Co., Ltd.), this was pulverized for 60 minutes under predetermined conditions (upper blade: V-shaped, lower blade: D-shaped, rotation number 2000 rpm) to obtain a pulverized solid electrolyte powder.

### Comparative Example 1

A crystalline complex degradate obtained in the same manner as in Example 1 was used directly as it was as a comparative object, and various measurement thereof were carried out. The resultant solid electrolyte powder was photographed with a scanning microscope (SEM) (FIG. 8).

### Comparative Example 2

A crystalline complex degradate was obtained in the same manner as in Example 1.

Next, 80 g of the crystalline complex degradate prepared in the above was put into a reactor equipped with a stirring blade, and 740 mL of heptane and 110 mL of diisopropyl ether (DiPE) were added and stirred for 10 minutes to obtain a slurry. Using a circulation operable bead mill (trade name: “Labo Star Mini LMZ015”, by Ashizawa Finetech Ltd.), the slurry was pulverized for 30 minutes, while kept circulated under predetermined conditions (bead diameter: 0.3 mmφ, amount of beads used: 456 g (bead filling rate to the grinding room: 80%), pump flow rate: 400 mL/min, peripheral speed: 8 m/s).

Further, the pulverized slurry was dried in vacuum at room temperature (23° C.) to obtain a pulverized solid electrolyte powder.

The measurement results in Examples and Comparative Examples are collectively shown in Table 1.

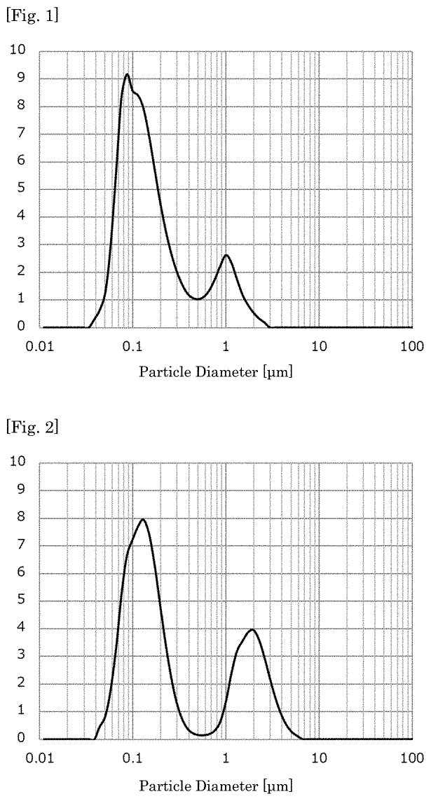

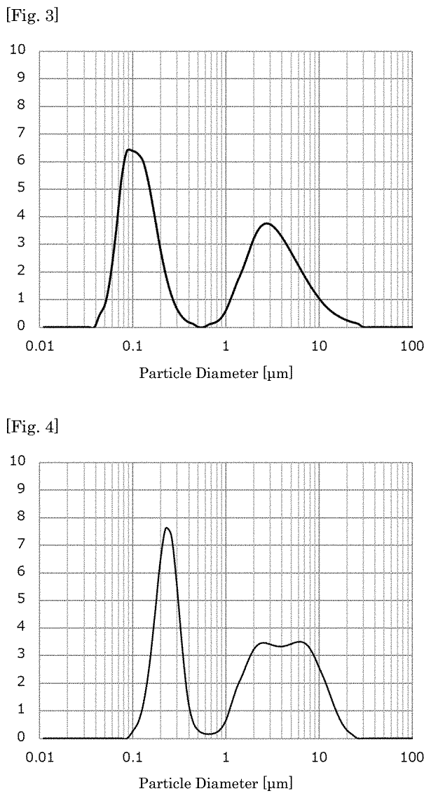

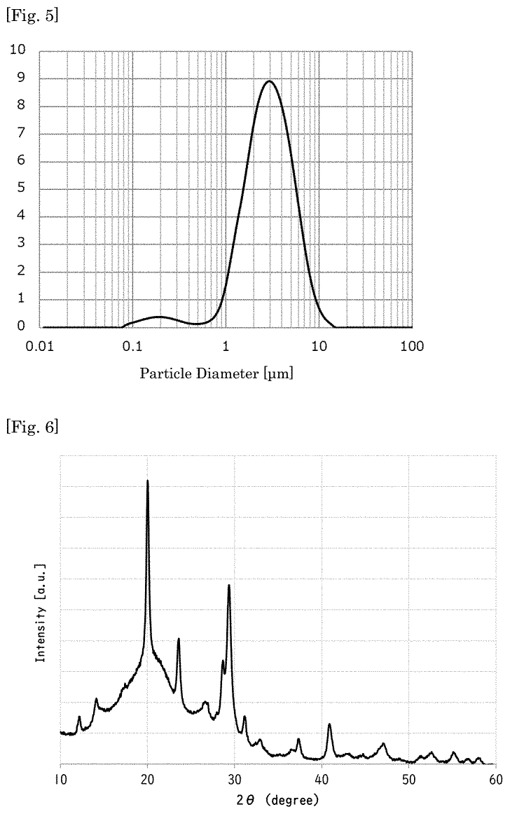

The particle size distribution of the sulfide solid electrolytes obtained in Examples and Comparative Examples is shown in FIGS. 1 to 5.

TABLE 1

| | | | | | | | Oil | |
|---|---|---|---|---|---|---|---|---|
| | | | | | | | Absorption | Remaining |
| | | | | | Oil | Specific | Amount/ | Complexing |
| | Integrated | Particle Diameter | | | Absorption | Surface | Specific | Agent |
| | Energy | d10 | d50 | d90 | Amount | Area | Surface Area | [% by |
| | [Wh/kg] | [μm] | [μm] | [μm] | [cm³/g] | [m²/g] | ×10⁻⁸ [m] | mass] |
| Example 1 | 120 | 0.07 | 0.12 | 0.87 | 0.91 | 30 | 3.0 | 0.3 |
| Example 2 | 16 | 0.07 | 0.15 | 2.14 | 0.78 | 29 | 2.7 | 0.8 |
| Example 3 | 56 | 0.07 | 0.21 | 5.41 | 1.02 | 27 | 3.8 | 0.6 |
| Comparative | 0 | 0.18 | 1.61 | 8.14 | 1.29 | 30 | 4.3 | 0.5 |
| Example 1 | | | | | | | | |
| Comparative | 4020 | 1.18 | 2.67 | 5.53 | 0.70 | 7 | 10 | 0.4 |
| Example 2 | | | | | | | | |

### INDUSTRIAL APPLICABILITY

In accordance with the production method for a sulfide solid electrolyte of the present embodiment, a sulfide solid electrolyte having a small oil absorption amount can be produced without lowering the specific surface area thereof. The crystalline solid electrolyte obtained by the production method of the present embodiment is suitably used for batteries, especially batteries to be used for information-related instruments, communication instruments and the like such as personal computers, video cameras, and mobile phones.

1: A method for producing a sulfide solid electrolyte comprising:
mixing a raw material inclusion containing a lithium atom, a sulfur atom, a phosphorus atom and a halogen atom, and a complexing agent to obtain an electrolyte precursor,
removing the complexing agent from the electrolyte precursor to obtain a complex degradate,
heating the complex degradate to obtain a crystalline complex degradate, and
pulverizing the crystalline complex degradate by applying thereto a mechanical treatment with an integrated energy amount of 10 Wh/kg or more and less than 500 Wh/kg to obtain a pulverized product.

2: The production method for a sulfide solid electrolyte according to claim 1, wherein the pulverization treatment for the crystalline complex degradate is performed in a solvent containing an oxygen atom-containing compound.

3: The production method for a sulfide solid electrolyte according to claim 2, wherein the oxygen atom-containing compound is an ether compound.

4: The production method for a sulfide solid electrolyte according to claim 2, wherein the solvent further contains a hydrocarbon compound.

5: The production method for a sulfide solid electrolyte according to claim 4, wherein the solvent contains 50 to 99.5% by mass of the hydrocarbon compound and 0.5 to 50% by mass of the oxygen atom-containing compound.

6: The production method for a sulfide solid electrolyte according to claim 1, wherein removal of the complexing agent from the electrolyte precursor is performed by drying.

7: The production method for a sulfide solid electrolyte according to claim 1, further comprising heating the pulverized product.

8: The production method for a sulfide solid electrolyte according to claim 1, wherein the complexing agent is a nitrogen atom-containing compound.

9: The production method for a sulfide solid electrolyte according to claim 8, wherein the nitrogen atom-containing compound is a compound having a tertiary amino group.

10: The production method for a sulfide solid electrolyte according to claim 1, wherein a particle diameter (D50) of a cumulative volume of 50% of the crystalline complex degradate in a laser diffraction scattering particle size distribution measuring method is less than 3.00 μm.

11: The production method for a sulfide solid electrolyte according to claim 1, wherein a particle diameter (D90) of a cumulative volume of 90% of the crystalline complex degradate in a laser diffraction scattering particle size distribution measuring method is 5.00 μm or more.

12: A sulfide solid electrolyte containing a lithium atom, a sulfur atom, a phosphorus atom, a halogen atom and 0.01 to 1.0% by mass of a complexing agent, of which a particle diameter (D50) of a cumulative volume of 50% in a laser diffraction scattering particle size distribution measuring method is 0.10 μm or more and less than 0.50 μm, and of which a particle diameter (D10) of a cumulative volume of 10% is 0.05 μm or more and less than 0.15 μm.

13: The sulfide solid electrolyte according to claim 12, of which the particle diameter (D90) of a cumulative volume of 90% is 0.10 μm or more and less than 10.0 μm.

14: The sulfide solid electrolyte according to claim 12, of which a specific surface area is 20 to 50 m²/g.

15: The sulfide solid electrolyte according to claim 12, further containing 0.01 to 0.5% by mass of an oxygen atom-containing compound.

16: The sulfide solid electrolyte according to claim 12, wherein the complexing agent is a nitrogen atom-containing compound.

17: The sulfide solid electrolyte according to claim 16, wherein the nitrogen atom-containing compound is a compound having a tertiary amino group.

18: A sulfide solid electrolyte mixture containing the sulfide solid electrolyte of claim 12, and the other sulfide solid electrolyte of which the particle diameter (D50) of a cumulative volume of 50% thereof in a laser diffraction scattering particle size distribution measuring method is 0.50 μm or more.

19: A method for producing a sulfide solid electrolyte mixture of claim 18, comprising mixing the sulfide solid electrolyte, and the other sulfide solid electrolyte of which the particle diameter (D50) of a cumulative volume of 50% thereof in a laser diffraction scattering particle size distribution measuring method is 0.50 μm or more.
